(19) United States
(12) Patent Application Publication
(10) Pub. No.: US 2007/0037605 A1
(43) Pub. Date: Feb. 15, 2007

(54) Methods and apparatus for controlling cellular and portable phones

(76) Inventor: James D. Logan, Candia, NH (US)

Correspondence Address: CHARLES G. CALL, 68 HORSE POND ROAD, WEST YARMOUTH, MA, 02673-2516, US

(21) Appl. No.: 11/582,607

(22) Filed: Oct. 18, 2006

Related U.S. Application Data
(63) Continuation-in-part of application No. 10/984,018, filed on Nov. 8, 2004.
Application No. 10/984,018 is a continuation-in-part of application No. 10/160,710, filed on May 31, 2002, now Pat. No. 6,816,577.
Application No. 10/984,018 is a continuation-in-part of application No. 10/680,643, filed on Oct. 7, 2003, now Pat. No. 6,996,402.
Application No. 10/680,643 is a continuation-in-part of application No. 09/651,542, filed on Aug. 29, 2000, now Pat. No. 6,631,271.
Application No. 10/680,643 is a continuation-in-part of application No. 10/160,711, filed on May 31, 2002, now Pat. No. 6,788,766.
(60) Provisional application No. 60/728,162, filed on Oct. 19, 2005.
(60) Provisional application No. 60/295,469, filed on Jun. 1, 2001.
(60) Provisional application No. 60/295,404, filed on Jun. 2, 2001.

(51) Int. Cl. H04B 1/38

(52) U.S. Cl. 455/567

(57) ABSTRACT

A system for controlling the magnitude or timing of the alert signal (e.g. ringing) generated to notify the user of a portable (e.g. cellular) telephone of an incoming phone call. Data values that indicate the status of the telephone are processed to control the character of the alert signals. These data values may include position data indicating the absolute location of the phone or the relative location of the phone with respect to another object, the level of ambient light or sound in the vicinity of the telephone, the time of day, the movement of the telephone, and/or whether the telephone is being held by the user.

### CROSS-REFERENCE TO RELATED APPLICATIONS

This application is a Non-Provisional of, and claims the benefit of the filing date of, U.S. Provisional Patent Application Ser. No. 60/728,162 filed on Oct. 19, 2005, the disclosure of which is incorporated herein by reference.

This application is also a continuation in part of U.S. patent application Ser. No. 10/984,018 filed on Nov. 8, 2004 by James D. Logan and Caren Thornburgh-Logan entitled “Communication and control system using a network of location aware devices for message storage and transmission operating under rule-based control” published as U.S. Patent Application Publication No. 2005/0153729 A1 on Jul. 14, 2005. application Ser. No. 10/984,018 was a continuation in part of U.S. patent application Ser. No. 10/160,710 filed May 31, 2002 which issued as U.S. Pat. No. 6,816,577 on Nov. 9, 2004, and which claimed the benefit of the filing date of Provisional U.S. Patent Application Ser. No. 60/295,469 filed on Jun. 1, 2001. application Ser. No. 10/984,018 was also a continuation in part of U.S. patent application Ser. No. 10/680,643 filed on Oct. 7, 2003 which issued as U.S. Pat. No. 6,996,402 on Feb. 7, 2006 and which was a continuation in part of U.S. patent application Ser. No. 09/651,542 filed Aug. 29, 2000 issued as U.S. Pat. No. 6,631,271 on Oct. 7, 2003 and of U.S. patent application Ser. No. 10/160,711 which was filed on May 31, 2002 and issued as U.S. Pat. No. 6,788,766 on Sep. 7, 2004, and which claimed the benefit of the filing date of Provisional U.S. Patent Application Ser. No. 60/295,404 filed on Jun. 2, 2001.

This application claims the benefit of the filing date of each of the above-noted applications, and incorporates the disclosures of each of the foregoing patents and applications herein by reference.

### BACKGROUND OF THE INVENTION

1. Field of the Invention

This invention relates to telecommunications systems and more particularly, although in its broader aspects not exclusively, to methods and apparatus for determining the location of a portable or portable telephone and controlling one or more functions performed by the portable phone in response to that determination.

2. Definition of terms

In this specification, the term “portable telephone” or “portable phone” refers to mobile or cellular telephones which communicate by long distance radio signaling with individual base stations or base stations in a communications network, as well as to portable telephones which communicate using shorter range radio signaling with a local base station typically in a home or office.

The terms “ring,” “ringing,” and “alert” refers to a audible, visible or tactile notification signal, or a combination of these, that can be perceived by a human and that are produced by audible ring tone generators, by one or more loudspeakers or acoustic transducers; by lights, semaphores or other visible signaling devices; and/or devices such as vibrators which produce signals that can be perceived by the sense of touch. Note that, as used herein, the term “ring,” “ringing,” or “alert” can indicate both the ringing typically produced by conventional telephones as well as to musical or other audio sound patterns generated by the handset to signal that a call is coming in.

The terms “volume,” “amplitude,” “magnitude,” and “intensity” are all used to refer to the magnitude of signals, light, sounds, pressures, vibrations, etc. that are either sensed by or generated by various components of the control system to be described.

Problems with Conventional Phones

Conventional cellular telephones permit users to set the ring tone to a particular volume. This volume, once set, stays the same until reset again. Often, resetting the volume level requires locating the reset function in a complex menu system, and is sufficiently cumbersome that users seldom reset the volume level. Instead volume is typically a set-once-and-leave-it feature.

This one-ring-tone-volume-fits-all approach has many problems, including the following:
First, the distance between user and the phone can vary considerably during the day, unless one is wearing or carrying the phone on their person. But many people leave their phone on their desk or at other handy locations to avoid having to carry it around.
Second, where the phone is kept can impact the effective ringing volume. That is, if the phone is deep in a purse or briefcase, the sound will be much muted compared to the volume that would result if the phone were resting on a desk.
Third, ambient noise can again impact effective volume. When standing at a trade show or on a noisy street comer the surrounding sound can be enough to drown out most ring tones, particularly if the volume setting was established when the noise level was low.
Fourth, setting the volume to an effective level for the owner may not be enough. The user has to consider the social situation and recognize that others who are nearby might not feel that a particular volume is effective for them. For instance, when one sets a phone down on a conference room table with others nearby, the volume might need to be different. Having a phone ring in church or a movie theatre may particularly undesirable.

Today, the primary approach to solving this problem has been to offer the user convenient (i.e. fast) means by which to switch back and forth between vibrate, ring, ring & vibrate, and silent modes. One purpose of the present invention is to automate the selection of ring mode (ring, vibrate, silent, or lights), or the selection of the ring volume or strength of vibration or brightness of the lights activated upon ringing, and the length or timing of such signaling (e.g. the length of time the phone should ring before sending the caller to voice mail). This automation is performed by altering the character of the ring signaling in response to a variety of sensed conditions, including the absolute or relative position of the phone, ambient conditions such as darkness or noise levels, adaptive responses to conditions learned from experience, or the satisfaction of conditions expressed by rules specified by the user.

### SUMMARY OF THE INVENTION

The following summary provides a simplified introduction to some aspects of the invention as a prelude to the more detailed description that is presented later, but is not intended to define or delineate the scope of the invention.

Embodiments of the invention are employed to automate the selection of an appropriate alert notification to signal the arrival of an incoming call directed to a portable telephone; for example, to automatically switch between a cellular telephone's ring and vibrate modes, to potentially activate alert lights upon receiving a ringing signal, and potentially control the strength of the light or vibrate mode. In accordance with one aspect of the invention, many of these operating modes may be automatically controlled by sensing the location of the portable phone, or of persons and objects near to the portable phone, and/or by sensing the characteristics of the environment in which the portable phone is being used, or by detecting the characteristics of the inbound telephone call.

These variations in the behavior of the portable telephone may be automated without needing attention from the user by responding to information indicating the location or mode of use of the phone, or changes in the environment in which the phone is used or the character of the calling party.

The preferred embodiment of the invention controls the magnitude or timing of the alert signal (e.g. ringing) generated to notify the user of a portable (e.g. cellular) telephone of an incoming phone call. Data values that indicate the status of the telephone are processed to control the character of the alert signals. These data values may include position data indicating the absolute location of the phone or the relative location of the phone with respect to another object, the level of ambient light or sound in the vicinity of the telephone, the time of day, the movement of the telephone, and/or whether the telephone is being held by the user.

The preferred embodiment can control a portable telephone (e.g. a cellular handset) by acquiring an indication of the current position of said portable telephone, and producing an alert that can be perceived by a human in response to an incoming telephone call directed to said portable telephone wherein the alert has one or more properties that are dependent upon the acquired position indication. The position indication may describe the absolute geographic location of the telephone, or its position relative to the current location of another object, person or region determined by detecting a signal produced by a beacon at a known location of said portable telephone.

The magnitude or timing of the alert signal may be varied in response to acquired status indications, including not only the relative or absolute location of the telephone but also sensed ambient conditions, such as whether the telephone is in the dark, the ambient sound level at the telephone, the time of day, whether the telephone is being held by the user, and the nature of the incoming call or caller. These data values may be used alone or in combination to alter the attributes of the alert signals produced. Programmed rules, each of which specified one or more conditions that are to be satisfied, and an action specification indicating the function to be performed when these conditions are satisfied, may used to process the status data and to generate alerts that are appropriate in different situations.

The mechanisms used to acquire the needed status data may include GPS or MPS subsystems for determining the absolute location of the portable phone; sensors for detecting and/or measuring the magnitude of signals received from identifiable beacon transmitters at known locations, sensors for detecting ambient light, sound, pressure which help determine the likely status of the telephone, and a built-in accelerometer that may be used to determine when and how the telephone has been subjected to movement.

Based on the determination of the status of the portable telephone derived from one or more of these acquired data values, the processor controls the mode, magnitude and timing of the alert signal. The likelihood that the user will be unable to perceive or respond to a given alert signal may be used to vary the characteristics of the alert notification to increase the likelihood that the call will be properly answered.

These and other objects, features and advantages of the invention may be better understood by considering the following detailed description of specific embodiments of the invention.

### BRIEF DESCRIPTION OF THE DRAWINGS

In the detailed description which follows, frequent reference will be made to the attached drawings, in which:

FIG. 1 is a block diagram illustrating the principal components of a cellular telephone that may be used to implement embodiments of the present invention;

FIG. 2 illustrates the exterior of a cellular telephone handset that includes a keypad and display which enables the user to view and interact with a menu display for selecting functions received from a remote party.

FIG. 3 is a block schematic illustrating how features of the invention are implemented using a web service that provides location based information;

FIG. 4 is a block schematic illustrating a network in which cellular and mobile phones communicate with other phones and information resources;

FIG. 5 illustrates a topology that is evaluated using a rules-based processor which controls the operation of a portable phone; and

FIG. 6 shows an HTML forms screen that illustrates how rules used by rules-based processing may be defined.

### DETAILED DESCRIPTION

Location Sensing

In some but not all of the embodiments of the present invention, the character of the alert produce when an incoming call is directed to a portable phone is controlled in part by determining the absolute or relative position of the portable phone. A variety of location mechanisms, in addition to those described in the patents and applications identified in the foregoing Cross-Reference to Related Applications, may be used to determine the position of the telephone. Representative mechanisms for determining absolute and relative locations are summarized briefly below.

The “Location measurement process for radio-frequency badges employing path constraints” described in Krumm et al. (Microsoft) U.S. Pat. No. 6,839,027 issued on Jan. 4, 2005. This patent, the disclosure of which is incorporated herein by reference, describes a process for measuring the location of people and objects carrying radio frequency (RF) transmitters that transmit messages to a plurality of RF receivers located in a space. Each receiver is in communication with a computer of a computer network and forwards data received from the transmitters to the network via its associated computer, along with a value indicating the signal strength of the received transmission. The signal strengths attributable to the same transmission are used to form a locating signal strength vector which is then compared to exemplary vectors generated from signal strength readings gathered in a calibration procedure from a set of representative locations in the space. In comparing the locating vector to the exemplary vectors, constraints are enforced on movements between locations (e.g., cannot pass through walls) and to probabilistically enforce expectations on transitions between locations.

U.S. Patent Application Publication No. 2003/0197607 by Striemer (IBM) published on Oct. 23, 2003 entitled “Modular school computer system and method” describes a local wireless device that serves as a unique identifier for students and teachers in a school system. The school is equipped with multiple stationary hubs for tracking the location of students and teachers. The school may also be equipped with multiple mobile hubs, such as hand-held hubs and hubs on school buses, which allow easily and quickly determining if a student or teacher is where he or she should be. Some of the functions may be disabled during class periods, but enabled between classes.

The position detection and location tracking system described in U.S. Pat. No. 6,674,403 issued to Gray, et al. on Jan. 6, 2004, the disclosure of which is incorporated herein by reference, performs real-time position detection and motion tracking of mobile communications devices moving about in a defined space comprised of a plurality of locales. A plurality of access points are disposed about the space to provide an interface between mobile devices and a network having functionality and data available or accessible therefrom. Knowledge of adjacency of locales may be used to better determine the location of the mobile device as it transitions between locales and feedback may be provided to monitor the status and configuration of the access points.

The following two patents assigned to Bluesoft, Inc., the disclosures of which are incorporated herein by reference, describe position detection systems that use Bluetooth transceivers: U.S. Pat. No. 6,731,908 issued to Berliner et al. on May 4, 2004 entitled “Distance measurement using half-duplex RF techniques” and U.S. Pat. No. 6,859,761 issued to Bensky et al. on Feb. 22, 2005 entitled “Accurate distance measurement using RF techniques” describes a method for determining the distance between two objects using an indirect propagation delay measurement. A frequency hopping scheme (such as the Bluetooth technology) is used to measure the relative phase offset of the received signal between the various frequencies. For a given distance between the objects, the phase offset vs. frequency curve is a straight line with the slope dependent upon the measured distance. After the phase of the received signals is detected, the data is plotted on a curve and the slope is calculated.

Two papers, “Bluetooth Positioning” by Josef Hallberg, Marcus Nilsson and Kåre Synnes and “Positioning with Bluetooth, IrDA and RFID”, a masters thesis by Josef Hallberg, Marcus Nilsson Master Thesis, Luleå University of Technology, 2002, describe three different ways of positioning with Bluetooth. With a registered positioning service, a Bluetooth device has an active role in the positioning task as it sends a position on request. A Bluetooth device can also take a more passive role in a positioning task wherein the unique address of the device is used by a connected device to look up a position in a database. In the third way, a position gained from a positioning platform is forwarded the Bluetooth connection. The cited papers presents a Bluetooth positioning system where the three ways of positioning are implemented, and describes the specific implementation of the system.

The Topaz® location detection system available from Tadlys Wireless Ltd . . . Rishon LeZiyyon, Israel, incorporates local area positioning software and a hardware system that calculates local position of Bluetooth tags and other devices (e.g. mobile phones, PDA's etc.). It provides up to 2-3 meters (7-10.5 ft) average positioning accuracy and can locate tens of tags simultaneously, covering areas of thousands of square meters. The Topaz indoor positioning system is particularly effective within buildings, where traditional positioning systems (particularly GPS) are ineffective, or inaccurate. The Topaz® location detection system is described in a white paper entitled “Indoor Location” by Dr. Zeev Weissman, Chief Scientist, Tadlys Ltd. (available at www.tadlys.com/media/downloads/Indoor_location_Systems.pdf).

As described in the above-noted paper by Weissman, four known methods are commonly used to provide indoor object location: Proximity Detection (PD), Received Signal Strength (RSSI), Time of arrival (TOA), and Angle of Arrival (AOA). Each of these methods may be used to determine the relative or absolute location of a portable phone in order to implement functions contemplated by the present invention:

Proximity Detection (PD)

This method relies upon a dense grid of antennas, each having a well-known position. When a mobile device is somehow detected by a single antenna, it is considered to be collocated with it. When more than one antenna detects the mobile device, it is considered to be collocated with the one that receives the strongest signal. This method is relatively simple to implement using infrared and radio signaling.

Triangulation

Triangulation takes proximity detection a step further, in the sense that it is based on measuring the signal level measurements from each antenna (possibly by using a triangulation mechanism), with respect to each mobile device. Following that, mobile is located by using a triangulation algorithm. This can be quite accurate outdoors. Indoor, however, it is susceptible to structure-related problems, such as multipath and non-uniform attenuation. Like the PD method, triangulation is relatively simple to implement, though there are some algorithmic intricacies that need to be solved to make the system accurate.

Time of Arrival (TOA)

TOA is based on triggering a remote device to respond, and measuring the time it takes for the response to flyback to the antenna. The elapsed time represents the distance between the two. By using distances from few antennas, a mobile's position can be triangulated. TOA is considered to be the most accurate method, because multipath effects can be filtered out, Yet, it is considerably more complex to implement, as it requires a modified hardware on the mobile side, as well as special modifications on the antenna side.

Angle of Arrival (AOA)

AOA is based on finding the direction of maximal signal intensity for each antenna-device pair. By finding the intersection of few such direction vectors, a mobile's position can be estimated AOA is considerably less accurate than TOA, due to limited angular resolution and the fact that indoor much of the signal is reflected. Also, AOA antennas are more complex, as they require multi-section, highly directional antennas, and multiple RF circuitry.

Cellular Phone Implementations

Cellular phones now typically include one or more microprocessors and sufficient memory resources to perform complex computational tasks. In addition, advanced cellular phones often include a Bluetooth short range signaling system which provides a communications interface to nearby devices and peripheral resources, as well as Wi-Fi connectivity to the Internet for data and voice communications over channels which may be independent of the cellular network. Moreover, the cellular phones include a display device which may be used in combination with the phones keypad to provide a robust user interface for accepting commands and preference data from the user that may be used to customize the manner in which alert signals are produced as contemplated by the present invention.

Portable Telephone Stationset Implementations

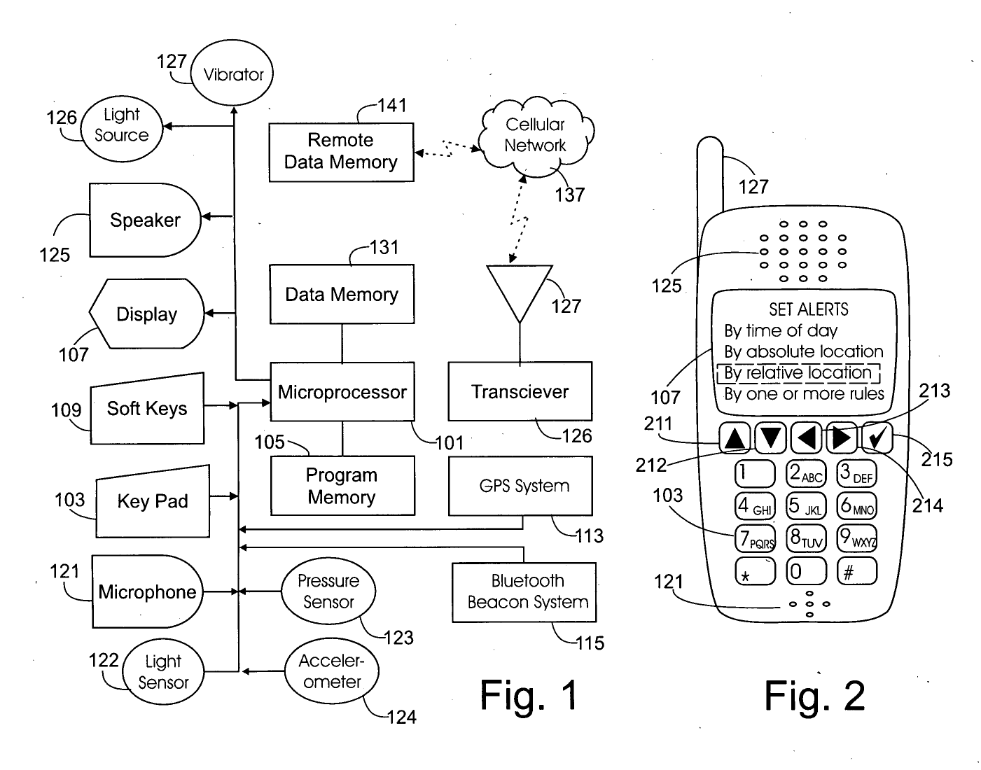

As described below, the invention may be used to particular advantage in connection with a cellular telephone and may be implemented using conventional components of the type commonly used in advanced cellular phone systems. The makeup and organization of these components is illustrated in FIG. 1 of the drawings and consists of a microprocessor 101 that executes routines initiated by the operator's manipulation of a keypad 103. Pressing a given key on the keypad 103 initiates a routine defined by a stored program in the program memory 105. The cellular phone further includes a display 107 that typically takes the form of a small, backlit monochrome or color LCD panel. The panel may be used to display a menu of items that may be selected by the user using “soft keys” seen at 109 that are visually associated with the displayed menu items. U.S. Pat. No. 5,737,394 entitled “Portable telephone apparatus having a plurality of selectable functions activated by the use of dedicated and/or soft keys,” the disclosure of which is incorporated herein by reference, describes the manner in which both the dedicated keys of a keypad and soft keys may be used in combination to implement a menu driven control arrangement for a cellular telephone. Alternatively, as will be described in more detail in connection with FIG. 2 of the drawings, the functions performed may be displayed as a list of options and cursor keys may be used to invoke selected functions and submenus identified on the display 107.

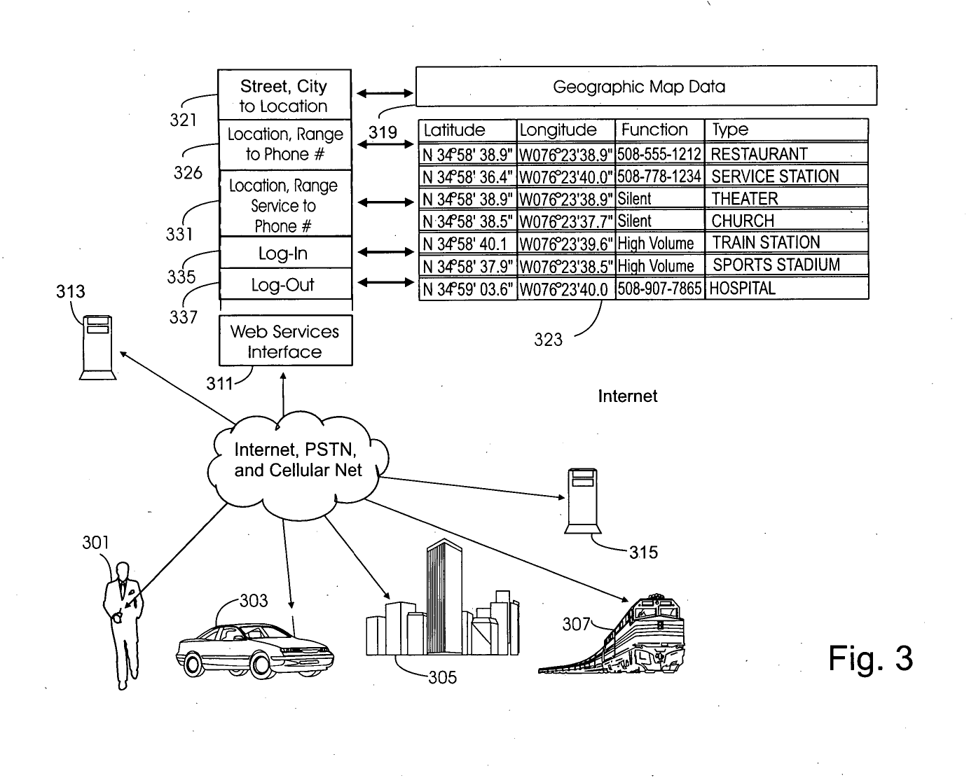

The cellular telephone preferable includes a built-in GPS system 113 which produces location data specifying the absolute geographic location of the cellular phone in latitude and longitude. This measured location may be compared with a location database to translate the measured position into data which is more easily understandable to the user, such as “Home”, “Office,” etc. Such a database may be remotely located as discussed in more detail later in connection with FIG. 3.

The cellular telephone also preferable includes a built-in Bluetooth transceiver which, in addition to other Bluetooth functions, operates as a Bluetooth beacon system 115 for detecting that other Bluetooth enabled objects are nearby, and for indicating its position to such objects. This Blootooth beacon system may be supplemented with an RFID tag reader (not shown) for detecting and identifying nearby objects which are tagged with RFID tags. The cellular phone may also implement an MPS cellular location systems. These mechanisms for sensing the absolute location of the portable phone, or its location relative to other objects or regions, are used to control the manner in which alert signals are sent to the user to indicate the arrival of incoming calls, and for other functions.

The cellular telephone further includes a microphone 121 for capturing spoken voice signals from the operator, a light sensor 122 for determining whether the cellular phone is in the dark, a pressure sensor or a capacitive sensor123 for determining whether or not the telephone handset is being held, an accelerometer 124 for determining if the cellphone is at rest or in motion, a speaker or earpiece 125 for delivering audible sounds to the operator, and a cellular transceiver 128 coupled to an antenna 127 for sending and receiving radio frequency transmissions to and from the cellular telephone via the cellular network (and/or the public switched telephone network) to a remote telephone station set as illustrated at 125 by a cellular phone having like functionality. In addition to conventional ringing signals whose magnitude and timing can be controlled by the processor 101 as described in detail below, a light source 126 may be illuminated to provide a visual alert, and the cellular phone's vibrator 127 may be activated to provide a tactile signal that can be felt by the user, typically when an audible alert would be inappropriate. The magnitude and timing of the light and tactile signals may be controlled in accordance with data values indicating the status of the telephone in the same way that the magnitude and timing of audible ringing or other sounds are controlled. The term “mode” is commonly used herein to refer to particular set of alert generators (audible, visible or tactile) that is selected to suit particular sensed conditions.

The light sensor 122 can be used to determine whether or not the telephone is in a dark location, such as a drawer, a briefcase or a coat pocket. The pressure sensor 123 or a capacitive sensor can be used to determine whether a cellular phone is being held or has been picked up. The accelerometer 124 can be used to determine whether the cellphone is in motion. All of these sensors may produced outputs that are recorded for a time, enabling a determination to be made, for example, of how long the phone has been in the dark, how long it has been held in the hand or effectively untouched, or how long it has been at rest without moving, or how long it has been vigorously in motion. Thus, if a phone has been in the dark and motionless for an extended time during daylight hours, a louder ring signal can be generated since the phone is likely not near the user and located in an enclosure that may the alert difficult to hear.

Note that, while the embodiment of the invention describes here uses a cellular telephone, the present invention is equally applicable to wired portable telephone station equipment connected to the public switched telephone system as well as with telephones which communicate in whole or in part via the Internet using VOIP connections. VOIP voice connections may be controlled using the Session Initiation Protocol (SIP), an application layer control simple signaling protocol. SIP is defined and described in RFC 2543 and is a textual client-server based protocol SIP that is designed as part of the overall IETF multi-media data and control architecture currently incorporating protocols such as RTP, the Real-time Transport (RTP) Protocol (defined in RFC 1889). RTP provides end-to-end network transport functions suitable for applications that require a mechanism for transmitting real-time data such as audio, video or simulation data, over multicast or unicast network services. The SIP/RTP mechanism is accordingly a further example of the mechanism by which telephone homepages may be transmitted via the telephone connection established for handling voice communications as contemplated by preferred embodiments of the invention.

The microprocessor 105 includes analog-to-digital conversion means for converting analog voice signals from the microphone 121 into digital form for storage in a data memory 131. In addition, using a text-editing program stored in program memory 105, the keypad 103 may be used to compose text messages, which are stored as character data in the data memory 131. Data memory may also used to store data in the form of text, graphics, video and audio which is transmitted to remote parties as one or more “homepages” as described in more detail in co-pending U.S. Patent Application entitled ““Multi-media telephone system” filed on Oct. 3, 2006 by James D. Logan et al.

The cellular system transmits and receives both voice signals to provide conventional voice communications as well as data signals which can be exchanged with remote telephone stationsets and with network call centers which provide supervisory control of connected cellular phones. The cellular phone may be implemented, for example, using available technology such as the Motorola's iDEN i730 multi-communication device which provides a conventional, bidirectional audio voice communications channel as well as the additional TCP data communications channel which permits the exchange of data signals with a remote system illustrated by the remote data memory seen at 131 in FIG. 1. The iDEN i730 includes a built in processor 101 which can be programmed using the Java 2 Platform, Micro Edition, also known as the J2ME™ platform, which enables developers to easily create a variety of applications, as described in the i730 Multi-Communication Device J2ME™Developer's Guide, Motorola Corp. (2003).

FIG. 2 shows the exterior of an illustrative cellular telephone handset which houses the components shown in the block diagram of FIG. 1 and which employees the same reference numerals to identify the same components shown in block and pictorial form in FIGS. 1 and 2. The handset uses a conventional numeric keypad 103 for dialing and soft keys whose function depends on the content shown on the display 107. The soft keys include an UP cursor key 211, a DOWN cursor key 212, a LEFT cursor key 213, a RIGHT cursor key 214, and an OK key 215.

When a menu screen is displayed as seen at 210, the cursor keys 211-214 are used to highlight a selected one of several displayed labels, and the OK key 212 is used to invoke the operation designated by the selected label. For example, as seen in FIG. 2, the display screen 107 may display a scrollable listing of labels each of which specifies a particular one of a collection of prerecorded messages. By pressing the UP and DOWN cursor keys 211 and 212, the user may highlight a selected label on the scrollable list, and may select the highlighted message by pressing the OK key 215.

The cursor keys may be used to select and activate a variety of control functions or to set preferences using program generated menus. The program memory 105 may include voice recognition routines for converting spoken commands into interface commands for selecting and initiating functions. In order to differentiate conventional speech from voice commands, a selected soft key or dedicated key, or a unique spoken command, may be used to place the device in voice command mode. In voice command mode, the user may select and invoke a particular function by speaking the word or words corresponding to one of the displayed labels. In each case, because the total vocabulary of acceptable spoken commands is limited, a speech recognition program of limited capability of the kind now commonly incorporated in cellular telephones to implement voice commands may be used.

As contemplated by the present invention, the programs stored in the program memory 105 automatically perform a variety of operations in response to sensed status conditions. In addition, the operator may initiate and perform a number of interrelated functions, any one of which can be performed by beginning with menu as illustrated at 210 in FIG. 2. As illustrated at 210, for example, the operator of the cellular phone may select from a listed set of options to enter preference data which is stored by the processor 105 in the data memory 131 to control the manner in which alert messages are generated and the character of those messages.

Location Sensing in the Portable Phone

The portable telephone preferably employs location-based information in combination with environmental data, time-of-day information, and user preferences to automate in whole or in part the selection of an alert signaling mode that is appropriate under detectable circumstances.

Thus, in this implementation, a user's phone would glean location data from a built-in technology such the GPS system, portable 911-triangulation, or even a locally-based system, such as a system of distributed Bluetooth beacons, that can specify the location of the portable phone within a building. The user would have the option to set preferences regarding when and where the portable telephone should ring and in what manner. Thus, in church or theater, it would be desirable that the phone operate in a silent mode, while at the doctor's office it might be desirable that the phone be placed in vibrate mode. Alternatively, the phone could be programmed to ring quieter or to ring for fewer rings before going into voice mail.

Since, in many situations, the nature of the alert to be issued is adjusted automatically, it will frequently be desirable that the phone display or otherwise indicate to the user that the phone had just undergone an automated change in the manner the alert will be produced. This could be indicated by a unique (or standard) sound, light indicator, or vibration pattern, and an accompanying explanatory display message.

The user could build up such a list of location-ring tone preferences piece-by-piece through “experiential data collection;” that is, every time the user is in a new movie theatre, and he sets his phone to the vibrate mode, the phone would ask whether the user wants this setting to be made permanent, or for one or more calls only. If the location sensing mechanism can determine the absolute or relative location at the time the mode is manually reset, the user may also be asked to indicate whether that new mode setting is to be applied whenever the existing location is again detected.

A central server with a stored map database (e.g. “Google Map” data or a web service as described below in connection with FIG. 3) might also know that the location where the setting is being made is a movie theatre. The user, therefore, when setting his phone for a particular ring tone volume and mode would be asked if he would like this same setting to apply to all movie theatres. Again, time could be additional dimension of the setting—that is, the ring-tone change would only be made during evening hours.

If a user deigned to set all movie theatres to a set ring-tone mode, a “pre-emptive” method might exist whereby the phone might query the user (preferably getting his attention via vibrate mode) regarding how the user might like the phone set up at a particular location. Therefore, if the user had his phone set to manner mode while at his church, but then attended a wedding at another church, the phone might recognize that the user was at a church and inquire as to whether the user wished manner mode to be invoked here as well. This pre-emptive method could be set the first time (or later) when the phone would ask, “Do you want to be asked to change your ring-tone settings at every theatre you enter?”

When the portable phone has been programmed to recognize that it has arrived at a location, or has otherwise detected conditions which would cause a change in the alert notification, the user may be notified and asked to confirm that the change should be made. The user may also program certain conditions to automatically change the mode without seeking confirmation.

Another method of setting ring-tone volume and mode would be to do so “globally”. In this method, the user would ask the phone (which would work in conjunction with the server and other data sources) to deduce the social setting and ambient sound characteristics of whatever location the user found himself in. Thus, using a detailed database that could correlate GPS coordinates or other location data with building types, functions (subway stations), and settings (outdoors at the beach), the system could make certain deductions concerning how loud the ring might need to be to be heard and whether the ring might need to be attenuated for social purposes.

When the user was in a location where a ring-tone modification had been made, rules-based location sensing or GPS motion detection, or the accelerometer 124, may be able to discern when a user is starting to move about. At that point, the system might offer the opportunity to switch the volume or mode setting or might do so automatically. For instance, if the user started to move within a movie theatre, the system might deduce the movie was over and thus allow the phone to ring. This relaxation of ring volume control could begin after a set time period (for instance two minutes after movement began) or based on distance (once the user had moved 100 feet). Alternatively, perhaps when arriving at the theatre, the ring-tone modification would only kick in after the user was seated, either for a moment or a set number of minutes. In any of these cases, (arriving, leaving, or even going to the concession stand) the movement data could reasonably discern that a change had occurred in the socially-acceptably ringing volume allowed. Such distance and time settings could be set by each user and could vary for each location or class of locations.

In a further enhancement, the system might have stored in a database movie start and end times, church service schedules, and other data that might be used to automatically modulate the ring tone volume or mode.

Location Based Web Services

FIG. 3 illustrates a communications network which may be used to implement some of the more advanced location based functions using the infrastructure described in the above-noted U.S. Pat. No. 6,788,766. As illustrated in FIG. 3, location based ring control can be provided as one of the web service functions provided by a database server which is coupled via a communications network to a cellular phone carried by a user seen at 301. Other participants in the system seen in FIG. 3 include a mobile cellular phone user 303, a stationary phone user in an office building 305, a cellular phone user on a train 307, and three data servers 311, 313 and 315. Each of the telephone users 301, 303, 305 and 307 employs a communications device which can communicate over the cellular and/or public switched telephone network, and through that network and the facilities offered by an Internet Services Provider, may also exchange data with any of the data servers 311, 313 or 315.

The data server 311 provides data services using standards based Web services (i.e. data lookup services which may be invoked by sending an XML SOAP request message containing a data request to which the data server responds with an XML SOAP response. The data server maintains a geographic map database 319 which permits the server 311 to respond to requests specifying a street address, city and state with a geographic “point location” expressed as a latitude and longitude value as indicated at 321. Using the location and function database seen at 323, a cellular phone 301 equipped with a GPS location sensor may transmit its current location as a geographic position designation comprising a latitude value and a longitude value to the database 311 when an incoming call arrives and when the cell phone user would normally be alerted. The database server 311 compares that location with locations recorded in the database to determine if the “manager” of a given location has suggested a particular alert signal setting. For example, if the cellphone is within a predetermined range of the THEATER whose location is recorded in the database, an indication is returned to the cell phone indicating that the ring tone should be silenced. Similarly, if the requesting cellphone indicates that it is located at or near the SPORTS STADIUM, the database server 311 returns an indication that the alert signal should be delivered at high volume because of the likelihood of high ambient noise levels.

The data server 311 not only provides information that enable the portable phone to automatically set the nature of the alert signals it issues, it converts the absolute geographic position data (latitude and longitude) into a name or symbol which indicates in human perceptible form the plane where the portable phone is located. For example, if the GPS system indicates that the portable phone is within a predetermined distance of geographic point or region called “Office.” that human-perceptible designation may be displayed or used to determine whether or not the currently detected position satisfies a rule condition that the phone be located at the “Office.”

Note that the alert setting function is only one of many services which can provided by a location server of the kind shown in FIG. 3. Additional functions are described in the n the above-noted U.S. Pat. No. 6,788,766. For example, by using the participant-location database 319 seen at 323, the server can respond to a request message specifying a geographic point and a range value with the telephone numbers of any participant that is located less than the stated range value from the stated point as indicated at 326. Further, as seen at 331, the server 311 can use the database 323 to respond to a request indicating a point location, a range value, and a service description with the phone number of any participant who performs the stated service and is located within the stated range of the stated point.

The server 311 further supports log-in and log-out messages in which a participant posts its current location, telephone number and offered service to the database 323, or alternatively a location and an indication of the ring tone characteristics that are appropriate when a requesting cellphone is in the vicinity of that location. Upon accepting the log-in data, the server returns a record number to the participant. The participant can thereafter log-out, cancelling its participation, by sending a log-out request which includes the supplied record number. At log-in time, the participant may further state the time during which the log-in data should remain in effect.

The Web of Rules

The character of the alert signals produced by a portable phone may also be controlled by a rule-based system in which sensed parameters, including the relative location of the portable phone with respect to other objects, people or regions are processed to determine if those parameters satisfy specified programmed conditions and, if the conditions specified by one or more rules are satisfied, then the “action part” of the satisfied rule specifies how the alert signal should be modified.

As described in the above-noted U.S. Pat. Nos. 6,631,271 and 6,996,402 entitled “Rules Based Methods and Apparatus for Generating Notification Messages based on the Proximity of Electronic Devices to One Another,” one or more specified functions may be performed in response to the changing relative positions of a plurality of objects, each of which incorporates or is attached to a device that can be identified at short range. One or more processing rules are defined by a user. Each of the rules contains condition part and an action part, with the condition part defining at least one relative position condition to be satisfied by specified ones of said objects and the action part defining at least one specified action to be performed when said condition part is satisfied. One or more detectors generate data indicating the identification and relative position of electronic devices that are within range of the detectors. This data is processed in accordance with the processing rules defined by the user, and functions are performed as specified in the action part of each of the rules whose condition part is satisfied by the data from the detector(s).

The detectors operate as interrogation devices capable of determining whether specified ones of the objects are within a predetermined range of the interrogation device, and may be implemented by Bluetooth compliant integrated circuits, by radio frequency identification (RFID) tag readers, or by devices which obtain position information from devices using the Global Positioning System (GPS).

One of the objects may be a container which holds one or more objects, and the condition part of a rule may define one or more relative position conditions to be satisfied by the position of the container relative to said one or more objects specified in the rule. An identification token, such as a card or a badge, may be issued to a designated bearer and the condition part of a rule may define a position condition to be satisfied by the position of the identification token relative to one or more other devices. This rule-based, location dependent system may used to advantage in a wide range of programmable applications defined using a standard user interface which a user employs to define the condition and action parts of rules which control a variety of defined functions in response to the changing relative positions of specific objects identified in the rules.

The action part of a user-defined rule may specify the content and destination of a message to be delivered when the condition or conditions specified in the action part is/are satisfied. This message may be a labeled, pre-recorded audio message stored either in a cellular phone handset or in a remote file server as discussed above and transmitted during on ongoing conversation which is occurring when the condition is satisfied, or may be transmitted to a called party after a connection is established to that party by dialing a telephone number specified in the action part of the satisfied rule.

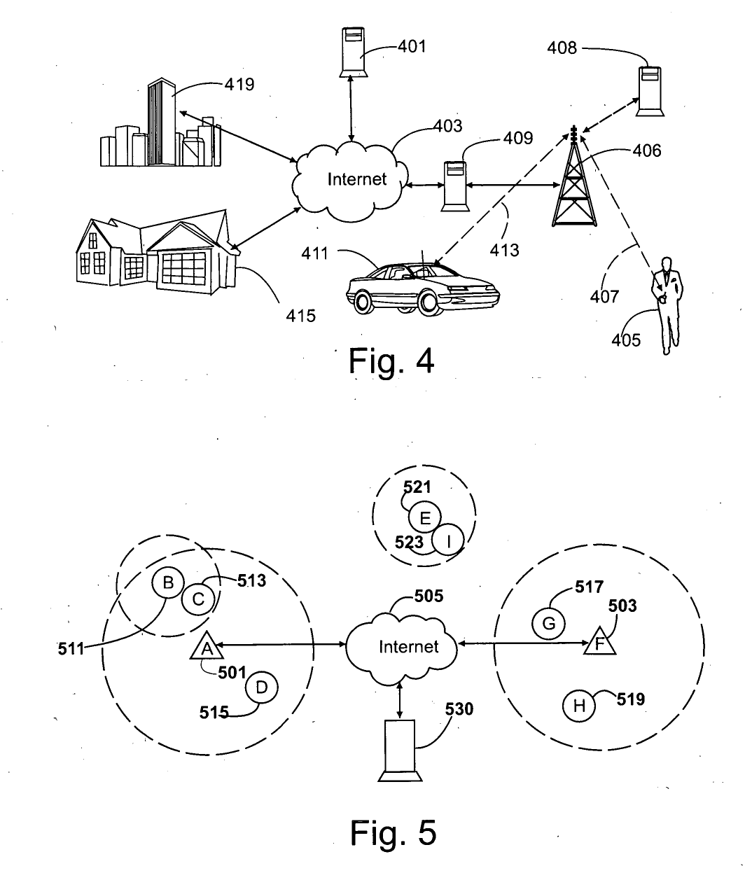

Using the rule-based system, the relative locations of a network of electronic devices, each including an electronic device whose absolute or relative position can be sensed, are monitored to generate notification signals in accordance with user-defined rules. An illustrative example of such a network is shown in FIG. 4. Supervisory functions for the system are executed on a server 401 which is connected via the Internet 403 to a plurality of different fixed and portable electronic devices which employ Bluetooth chips, RFID tags and tag readers, or other radio frequency devices to sense the relative location of devices in the network as well as provide connectivity between the devices.

For example, the user seen at 405 uses a hand held cellular phone which is connected to the Internet 403 using a cellular network or Wireless Application Protocol (WAP) radio link 407 and a gateway server 409. Similar, the user's automobile 411 employs a second cellular or WAP link 413 and the gateway 409 to connect to the Internet. Additional electronic devices, such as personal computers, at the user's home 415 and office 419 are also connected to the Internet via conventional means, including dialup and fixed connections to Internet Service Providers (ISPs). Each of the foregoing devices are thus provided with Internet connections and each is further provided with a Bluetooth chip which enables that device to communicate over short ranges to still further devices (not shown in FIG. 4). For example, the user 415 may carry additional devices, such as a laptop computer or a personal device assistant (PDA), an electronic wristwatch, a remote control for an automobile door lock, a digital camera, or an electronic calculator. Each of these devices may be equipped with a Bluetooth chip which can communicate with other devices, including the user's cellular phone which includes a Bluetooth chip that enables it to also operate as a short range intercom device and as a portable phone when it is the vicinity of a base station at the user's home 415 or office 419.

The user's automobile 411 is also equipped with a cellular phone system capable of establishing data communications via the WAP gateway 109 and the Internet 403 to provide information, entertainment, and communications services to the occupants. The automobile may be further provided with a navigation system using the Global Positioning System (GPS), a diagnostic system capable of generating, displaying and transmitting status information about the automobile, The automobile's car locking system may employ a Bluetooth enabled transceiver to remotely control door and truck locks, lights, and anti-theft alarms.

At the user's home 415 and at his or her office 419, Bluetooth enabled devices may be integrated into a variety of fixed systems, including thermostats, appliances, entertainment systems, lighting controls, security systems, and office equipment. Although the Bluetooth chips in these devices may be primarily intended for different functions, they can play a useful role in the position monitoring and notification system contemplated by the present invention, a described below.

The invention may be advantageously applied to automatically control the characteristics of alert signals issued by portable devices to notify their users when actions (such as answering an incoming call) are expected. By using the user-defined rules for monitoring the relative and absolute positions of various devices, in combination with user-defined actions which should be performed when associated conditions are satisfied, the system can be tailored to the needs of the particular user and the specific devices which that user owns and operates.

Bluetooth Functions

The built-in ability of Bluetooth devices to determine when one Bluetooth device is within a predetermined range of another Bluetooth device can be used to advantage in a system for automatically controlling the characteristics of generated alert signals.

As described in Profiles, Specification Volume 2, Specification of the Bluetooth System, V1.0B, Dec. 1, 1999, under the Generic Access Profile, two devices involved in a Bluetooth communication can take the roles specified by the generic notation of the A-party (the paging device in case of link establishment, or initiator in case of another procedure on an established link) or the B-party (paged device or acceptor). The A-party is the one that, for a given procedure, initiates the establishment of the physical link or initiates a transaction on an existing link.

The Bluetooth access profile establishes the procedures between two devices related to discovery and connecting (link and connection establishment) for the case where none of the two devices has any link established as well as the case where (at least) one device has a link established (possibly to a third device) before starting the described procedure. The Bluetooth user should, in principle be able to connect a Bluetooth device to any other Bluetooth device. Even if the two connected devices don't share any common application, it should be possible for the user to find this out using basic Bluetooth capabilities.

Each Bluetooth device is specified by a unique 48-bit (12 hexadecimal digit) Bluetooth Device Address (BD_ADDR) and by a “user friendly” Bluetooth Device Name which can be up to 248 bytes long, although external devices are not expected to be able to handle or display more than 40 characters. Still further, each device is assigned a Bluetooth passkey (Bluetooth PIN) which is used to authenticate two Bluetooth devices (that have not previously exchanged link keys) to each other and create a trusted relationship between them. The PIN may be entered through a user interface device and may also be stored in the device; e.g. in the case of a device without sufficient capability for entering and displaying digits.

Bluetooth devices are further specified by a Class of device parameter received during the device discovery procedure and indicating the type of device and which types of service that are supported. The information within the Class of Device parameter is referred to as ‘Bluetooth Device Class’ (i.e. the major and minor device class fields) and ‘Bluetooth Service Type’ (i.e. the service class field). The terms for the defined Bluetooth Device Types and Bluetooth Service Types are defined in the specification. The Class of device is a bit field and, at the user interface level, the information in the Class of device is implementation specific. Bluetooth devices are capable of performing an inquiry function to determine the identity and Device Class of other “discoverable” Bluetooth devices which are in range. With respect to inquiry, a Bluetooth device shall be either in non-discoverable mode or in a discoverable mode; that is, the device shall be in one, and only one, discoverability mode at a time. The two discoverable modes defined here are called limited discoverable mode and general discoverable mode. When a Bluetooth device is in non-discoverable mode it does not respond to inquiry. A Bluetooth device is said to be made discoverable, or set into a discoverable mode, when it is in limited discoverable mode or in general discoverable mode. Even when a Bluetooth device is made discoverable it may be unable to respond to inquiry due to other baseband activity. A Bluetooth device that does not respond to inquiry for any of these two reasons is called a silent device.

Bluetooth devices are capable of perform different types of inquiries called a (1) general inquiry, (2) limited inquiry, (3) name inquiry, (4) device discovery, and (5) bonding. The purpose of the general inquiry procedure is to provide the initiator with the Bluetooth device address, clock, Class of Device and used page scan mode of general discoverable devices (i.e. devices that are in range with regard to the initiator and are set to scan for inquiry messages with the General Inquiry Access Code). Also devices in limited discoverable mode will be discovered using general inquiry. The general inquiry is intended to be used by devices that need to discover devices that are made discoverable continuously or for no specific condition. The purpose of the limited inquiry procedure is to provide the initiator with the Bluetooth device address, clock, Class of Device and used page scan mode of limited discoverable devices. The latter devices are devices that are in range with regard to the initiator, and may be set to scan for inquiry messages with the Limited Inquiry Access Code, in addition to scanning for inquiry messages with the General Inquiry Access Code. The limited inquiry is intended for use by devices that need to discover devices that are made discoverable only for a limited period of time, during temporary conditions or for a specific event.

The purpose of name discovery is to provide the initiator with the Bluetooth Device Name of connectable devices (i.e. devices in range that will respond to paging). A Name request is the procedure for retrieving the Bluetooth Device Name from a connectable Bluetooth device. It is not necessary to perform the full link establishment procedure) in order to just to get the name of another device. In the name request procedure, the initiator will use the Device Access Code of the remote device as retrieved immediately beforehand normally through an inquiry procedure. The purpose of device discovery is to provide the initiator with the Bluetooth Address, clock, Class of Device, used page scan mode and Bluetooth device name of discoverable devices. During the device discovery procedure, first an inquiry (either general or limited) is performed, and then name discovery is done towards some or all of the devices that responded to the inquiry. The built-in ability of a Bluetooth device to detect the presence and identity of other Bluetooth devices which are within its range may be used to provide location information which is then used, as described below, to generate useful notification messages to the user.

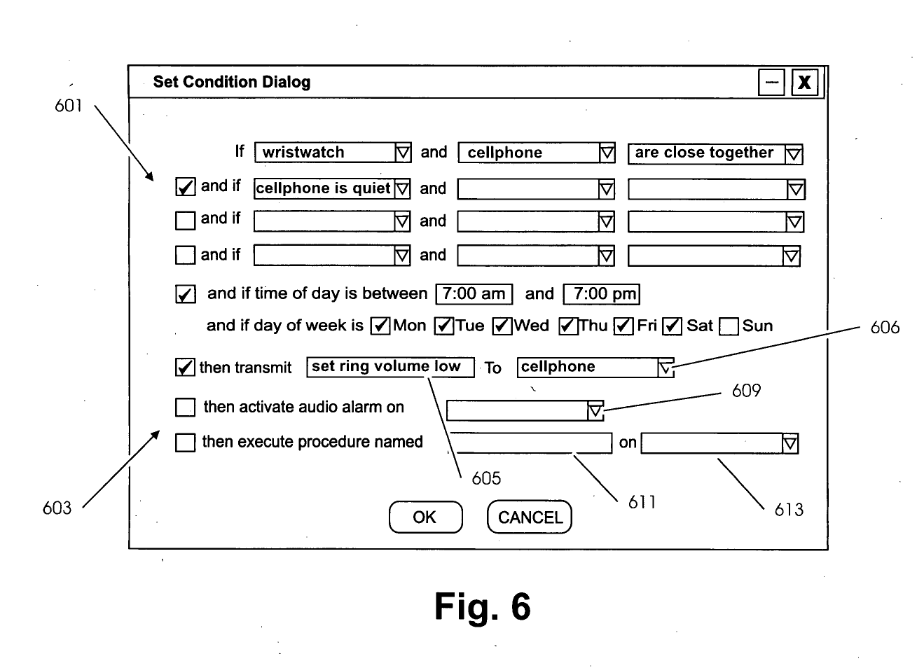

An illustrative topology is shown by way of example in FIG. 5. As there shown, two fixed Bluetooth devices illustrated by the triangles A and F at 501 and 503 are each linked to the Internet as seen at 505, and both can operate in a long range mode. Thus, the device illustrated by the triangle A at 501 can discover the presence of and communicate with the Bluetooth devices illustrate by the circles B, C and D at 511, 513 and 515 respectively. The device indicated by the circle B at 511 operating in short range mode can detect the nearby device C at 513, but the device D at 515 is out of range for the device B. The devices indicated by the circle G at 517 and by the circle H at 519 are both within the range of the device F at 503. The device indicated by the circle E at 521 is out of the range of both the devices A and F, but is near to and can discover the presence and identity of device I at 523.

Those Bluetooth device which are programmable (e.g. personal computers, PDAs, and the like) may be readily programmed to detect and report the position of nearby devices. Thus, the device A may be programmed to detect the fact that devices B, C and D are within its range, that devices E, F, G, H and I are outside its range, and that device C is also within the range of device B but that device D is not within the range of device B.

A server seen at 530 is connected to the Internet, and hence to devices A and F. The server 230 receives HTTP messages from the remote devices A and F containing the position information obtained by transmitting Bluetooth inquiry messages from devices A and F, and by gathering position information obtained from satellite Bluetooth devices, such as the device B. The server 530 executes a supervisory program which records the position information contained in received messages to establish state information at predetermined times. By comparing the state information at different times, transition events can be detected. Thus, if device B moves outside the range of device A, the time at which that movement occurred can be determined.

Other Range and Position Detection Systems

Other systems can be used to identify when particular objects are within a predetermined range of other objects. For example, identification tags which can be detected at short range are used in electronic article surveillance systems to prevent shoplifting and theft, warehousing and inventory control systems, article processing and inspection systems, and the like. Such systems are available from Unisen of Boca Raton, Fla.; Detectag of Aurora, Ontario, Canada; and Sensormatic of Boca Raton, Fla. Using these range-sensing, tagging mechanisms in combination with the user-defined rules contemplated by the invention, the user can tag articles which should be, or should not be, in particular places at particular times, as defined by the condition part of user-specified rules.

There are several different kinds of radio frequency identification (RFID) technologies and tags, each of which has significantly different functional characteristics. Some tags have batteries, some don't. Some tags have short-read ranges, some have long-read ranges. Popular tags operate on at least six different frequencies, often with many competing protocols at each frequency. To provide standards for identification tags, the EPC (Electronic Product Code) has been proposed to as a standard way of designating products, and packaging for products, in a range of retail supply chain application from “backroom” applications such as pallet and carton tracking to “selling floor” applications such as item level tagging. At its most basic level, EPC is a coding scheme for RFID data that will identify an individual item's manufacturer, product category and unique serial number. EPC tags are interrogated by tag readers which transmit the EPC code along with an identification of the particular reader to a server on the Internet which stores information that allows individual items to be tracked. Thus, for example, the server 530 may store tracking data for individual items made by a manufacturer. When the item is near a reader; for example, when an item bearing an RFID tag (device G at 507) is near a tag reader (device F at 503), that proximity information may be posted as tracking data to the server 530 via the Internet 530 using the standard EPC Network mechanism.

In addition to, or as an alternative to, the range finding abilities of a Bluetooth device, an article surveillance system, or the equivalent, an object whose position is to be tracked may incorporate a Global Positioning System (GPS) receiver for determining the absolute position in latitude and longitude for that device. For example, the GPS 25 series receivers available from Garmin Industries provide position information accurate to within 5 meters, velocity information accurate to 0.1 m/s RMS, are small in size (46.5 mm×69.9 mm×11.4 mm), and consume little power (115 mA typical@5.0 VDC). For details on the Global Positioning System and GPS receivers, see Understanding GPS:Principles and Applications by Elliott D. Kaplan (Editor), Artech House; ISBN 0890067937 (1996). Motorola offers the MG4100 Instant GPS chip that can detect GPS signals as low as −53 dBm, that can be readily added to virtually any portable consumer electronics product to provide position awareness. For example, digital cameras might stamp photos with time and location labels, PDAs can provide maps with real time navigation, and cellular phones that are E-911 compliant can offer emergency assistance, navigation, buddy finders, and location-based interconnections with others. Methods and apparatus for providing location dependent cellular telephone communications are further described in co-pending U.S. patent application Ser. No. 10/160,711 filed on May 31, 2002 and published on Dec. 5, 2002 as U.S. Patent Application Publication No. 2002/0181684 A1, the disclosure of which is incorporated herein by reference.

In addition, Mobile Positioning Systems (MPS) which are incorporated into cellular phone systems provide a mechanism for continuously or periodically updating location information for cell phones. MPS technology is similar to the satellite-based Global Positioning System (GPS) but offers the additional capability of determining location inside buildings, parking garages and other shielded areas such as inside a pocket or briefcase that are inaccessible to GPS systems. MPS Mobile Positioning Systems for GSM cellular phones are offered by Erickson and Cellpoint, Inc.

When a GPS or MPS device is used to determine absolute position, the user defined rules which determine when predetermined actions are performed may include absolute position requirements. For example, the GPS receiver in an automobile navigation system may be used to add a condition to the condition part of a rule which states “If my automobile is more than 2 miles from my house, and . . . ”

A rules-based system for monitoring the movement and relative location of a plurality of electronic devices, including Bluetooth compliant devices, RFID tags and RFID tag readers, and GPS devices, may be employed to perform specified actions, such as issuing alert messages having programmed characteristics, when the conditions specified in one or more or the defined rules are satisfied. The alert messages may consist of conventional telephone ring tone signals, or pre-recorded spoken messages or audio files which are specified by unique labels or identifiers and which may be annunciated at the time a condition is satisfied, or may be transmitted to a called party at a telephone number specified in the action part of the rule. RFID tag readers perform inquiry operations to identify RFID tags which are with range of the tag reader. The RFID tag readers may be connected in a network using the long-range communications capabilities of an included Bluetooth device, or via some other communication link. The current and past position of an item designated by an RFID tag which produces a standard EPC code may be determined using the standard EPC Network from an Internet server that stores tracking data for manufactured items. The positional data derived from these inquiries is passed to a rules processor which initiates defined actions when one or more of the rules are satisfied. A web server may be used to accept rules definitions, receive posted positional data from connected devices, and initiate the actions specified by the satisfied rules. Alternatively, user devices may be programmed to perform one or more of these functions.

The present invention may be used to provide programmable alert notifications or other messages by monitoring the relative locations of Bluetooth enabled or RFID tagged items that can be detected at short range to provide special electronic article surveillance functions to prevent shoplifting and theft, or to existing augment warehousing and inventory control systems, article processing and inspection systems, and the like. The Bluetooth enabled devices and the RFID tag readers are each coupled to a communications network, which may include the Internet, whereby position and identification information is passed to a processor which processes the supplied information in accordance with the previously defined rules. Some of the nodes of the network may act as relay stations, transferring device position and identification information from other nodes, or transmitting messages whose content and destination is specified by the action part of a rule whose conditions part has been satisfied.

The range and absolute position data from the network of electronic devices may be advantageously stored in a relational database and manipulated using standard query services and procedures. These query services process location data which may specify the geographic “point” position of fixed objects (without absolute position sensing means) or movable objects which are detected near to fixed objects, and movable object which use GPS or MPS mechanisms to determine current position. When precise data is unavailable, objects' positions may be approximated by specifying defined regions which contain the objects. Preferably, this location data is stored in a standard format, such as that used by the above-noted Oracle Spatial database mechanism that provides a SQL schema and functions that facilitate the storage, retrieval, update, and query of collections of spatial features in an Oracle8i database

Rules Definitions

The supervisory program executing on the server 530 can further accept rules definition from a user. For example, using a conventional forms based HTML/CGI interface, the user may specify the conditions which are to be satisfied before certain actions may be taken. By way of example, the user may define rules with the goal of making sure a user does not forget to take certain devices with their person. These devices or things that people commonly carry with them and that have some value include a Palm Pilot, cell phone, wallet, keys, pocketbook, briefcase, and portable computer. Each of these items would be equipped with a Bluetooth chip. In addition, Blue Tooth chips could be integrated into a small device (here called a “badge”) whose prime function is to indicate position and which can be could placed on or near stationary devices, such as the Palm docking station, or the cell phone recharger, with which Bluetooth devices or things bearing other Bluetooth badges could link to at times.

The “web of rules” of rules defined by the user could detect and inform the user of a rich variety of events. For instance, if the user's electronic watch was in proximity to her car during the day on Monday through Friday, then the user's cell phone and briefcase should also be in proximity to the car. That is, the cell phone and briefcase should be with the user when she is traveling, and the location of the watch signifies the location of the user. Thus, the user can define a rule which states that, if the watch is within the range of the car during business hours on Monday through Friday, and further if either the cell phone or the briefcase are not in the vicinity of the car at that time, the user should be alerted in of a variety of user-defined ways as described later. As a further example, the user could establish the rule that if the user left the house (as determined by being out of range of the particular fixed device), and a house security system indicated that the doors were not locked, and if no other user was still present in the house, the departing user would be alerted.

The action taken when a give rule is satisfied can take numerous forms. In the foregoing example, the user can be notified by a actuating a suitable alarm on a device known to be with the user (e.g., by causing her watch it sound an audible alarm or to vibrate.). Other actions can be taken when a condition is satisfied. For example, when the user enters the car for the first time when the state information indicates a different person had formerly used the car, the cars seats could be automatically adjusted for the new driver. As another example, when the system indicated that the user had left her house or her office at particular times of day, the telephone system could be programmed to automatically start call forwarding calls to a different location, or to automatically select a different greeting message that callers would hear when the calls were unanswered.

The supervisory program executing on the server (seen at 401 in FIG. 4 and at 530 in FIG. 5) could also currently report the position of articles. Thus, if the user had neglected bring her car keys, she could consult a display on her cell phone provided from the server using via the PDAs WAP interface, which might inform her that her keys (and its Bluetooth car lock control) were within range of the television set (with its Bluetooth remote control) her bedroom. The rules can be defined by the user using an HTML forms-based interface on a Web server, or by running a program for accepting rules on one of the user's electronic devices, such as a personal computer. An example rule definition form is shown in FIG. 6. Each rule consists of up to four positional conditions as indicated generally at 601, each of which can specify two devices and each of which can state whether that particular positional condition is satisfied when those two devices (1) are close together; (2) are separated, (3) have moved together, or (4) have moved apart. The first two possibilities can be determined by either of the devices issuing an inquiry to identify other electronic devices which are within its range, and the second two possibilities can be determined by comparing the current state of one of the devices with its prior state to determine which, if any, other devices have moved with range or have move out of range between states. The dropdown boxes at the left may also list single conditions: (a) cellphone is quiet, (b) cellphone is noisy, (c) cellphone is dark, (e) cellphone is lighted, (f) cellphone is held, and (g) cellphone not held. In addition, the dialog form seen in FIG. 6 allows the user to state the time of day and the days of the week when the conditional test is to be performed.

As seen in FIG. 6, the illustrative HTML form further defines an action part at 603 which specifies functions to be performed when all of the conditions in the condition part of the rule are satisfied. The user can enter the text of a message to be displayed at 605 and specify the electronic device which is to display the message at 606. The message may be a recorded spoken message or audio file designated by a user-defined label that is entered at 605, and the destination device which produces the message may be the telephone number of a called party to who the specified recorded spoken message or audio file is transmitted after a connection is established the cellular or public switched telephone network (PSTN). The user can also specify that, if the condition part of the rule is satisfied, an audible alarm on a device specified at 609 may be activated; and/or the user can designated a named procedure at 611 to be performed on a programmable device identified at 613.

The rule-based system may be used to produce “place-based” alarms. The user may define a rule such as “If my wristwatch is at my office and the time of day is between 5:00 pm and 6:00 pm, then activate an audio alarm on my wristwatch.” In this way, a reminder to leave the office on time is issued only if the user has not already left on time. As a further example, the user may record an reminder announcement on her GPS cell phone as a labeled message which play “pick up your prescription” whenever the cell phone was cell phone and the user's drug store “are close together.” Note that such reminder and alarm messages might be posted by a person other than the bearer of a designated device; thus, a person's spouse might post a reminder message “Don't forget to stop for milk” which would be transmitted to a designated cellular phone when that phone moved away from the phone user's office.

The cellular phone with a built-in message recording and playback mechanism may also be used independently of the rule-based network to autonomously play recorded reminder and alert messages at particular times or, if also equipped with GPS or MPS position sensing, to automatically play recorded reminder or alert messages when the cellular phone arrives at or leaves a designated geographical location, or to generate an identified recorded message or activate an alarm when a specified combination of time and location conditions were satisfied.

The cellular phone could also be programmed to record and play back place-related audio notes. For instance, you might want to make a note regarding which hotel room to ask for next time you at a particular hotel, or which dish to order at a particular restaurant, where to park when in a certain part of town. As previously noted, these recorded reminder messages may be stored either in the cellular handset, in a cellular network server, on an Internet server which is accessible to the cellular phone, or on a nearby device coupled to the cellular phone by a Bluetooth link.

Note also that, although the foregoing illustrative examples employ a cellular phone with message recording and playback capabilities, similar functions may be performed by a device such as PDA which may be provided with audio file recording and playback capabilities, data storage and processing capabilities, and short and long range communications. As described in detail in the above noted U.S. Pat. No. 6,788,766 which is incorporated herein by reference, a data server may be employed for facilitating communication between consenting participants via a telephone network. The data server stores cross-referencing data that specifies, for each of given participant, the current geographic location and the telephone number of each participant. New participants enter a group by sending a log-in message containing data specifying the current geographic location and the telephone number of the new participant. Any participant may then transmit a broadcast request specifying a geographic region within which a targeted subset of said participants are currently located, and broadcast an information message to that targeted subset of participants.

This mechanism for creating “talk groups” may be employed for automatically establishing connections between electronic devices which satisfy a particular rule. For example, when a participant's cellular phone entered or leaves a defined region, the user may be automatically logged into and out of a defined group, and pre-recorded announcements may be generated at the time of entry and exit which advise the user that group connectivity has been established.

This same technique could be used give the user to automatically connect to a source of information related to a particular location: pre-recorded announcements may be played when the user's device is at a predetermined position, such as particular battle sites at Gettysburg, or points of interest around Niagara Falls. A cell phone user may be given the ability to automatically be connected to a “help desk” in a large retail store to obtain shopping assistance from assigned store personnel. This connection could take use an “open-mike” conversation format in which, whenever the user speaks, all of the other group participants can hear them. A cell phone user with a headset could simply walk into a store and start talking to the clerks or information service. No more stationing kiosks or clerks all over the floor. Note that cellular phones or other devices with built-in short range signaling capabilities such as Bluetooth can automatically establish rule-based, location-based group communications among nearby participants without needing the cellular or dialup telephone network In some respects this capability is similar to the private intercom functionality is built into a basic cell phone service, but rather than establishing private communications between two parties, this system provides communications between all participants in the group which satisfy the rules defining the attributes of group members. Although these attributes may be location based conditions, they may be based on the attributes of participants; for example, creating discussion groups among all participants who share a common interest.

Group formation could be more than just based on where a user or device is currently located. These locations may be specified in a variety of ways, including using GPS and GIS map databases, as noted above. In addition, book-marking system could be employed whereby you can bookmark a location that you are currently at, and then refer back to it later. Marine GPS systems commonly include such a “man overboard” mechanism for marking a location to which the boat owner wishes to return.

Another useful action that a rule-based or location-based system can perform is to disable a designated device when a specified condition is satisfied. Thus, a cellular phone might be disabled unless it is near a designated wristwatch, effectively making the cell phone useful only by, or in the presence of, a particular person. Alternatively, a cell phone might be disabled when it is near to an automobile to prohibit unsafe use when driving, or it may be disabled when it is in a location that prohibits cell phone use, such as a theatre or other location designated by the user. Alternatively, the action part may merely disable the ringer, or switch it to vibrate mode, in certain locations, and return it to normal audible ringing mode upon departing from those protected locations. In the same way, a rule could be written to turn OFF the ringer, or disable or power down the phone or other devices at certain times of day when they are not needed, thereby conserving the battery supply.

The action part of a rule-based, including location-based, mechanism may identify pre-recorded DTMF (dialtone) signaling which can be transmitted via a cellular or dialup telephone link to control the state and function of a connected central office or cellular network provider. For example, most public telephone services offer a variety of service functions which can be controlled by transmitting predetermined dialpad key sequences. To use many of these functions, the user must normally know and key-in control key sequences on the telephone keypad. These key sequences can be recorded, labeled, and transmitted via the telephone link to perform a variety of functions, including: the activation and deactivation of call waiting services, the blocking and unblocking of caller ID displays, establishing call-forwarding functions. As a alternative to the use of DTMF key sequences to control telephone central offices, the SS7 call management protocol may be used. SS7 (Signaling System 7/Common Channel Signaling) is an advanced signaling system that features flexible message formatting, high speed data transmission (56/64 kbps) and digital technology. In the usual voice and signaling network, signaling and voice use the same path but cannot use it at the same time. With SS7, signaling and voice have been separated. Signaling (SS7) is over a high-speed data link which carries signaling for more than one trunk. In the context of the present invention, the SS7 protocol provides a more direct and effective way for the host services computer to control the functions of the connected dialup telephone system than the conventional DTMF signaling mechanisms which are set forth here for simplicity.

If the subscriber wishes to prevent the called parties caller ID system from displaying the subscribers number on the next call, the rerecorded sending the dialtone sequence “*67” is sent to the central office. The sequence “*82” may be recorded and sent to remove perform line blocking for the next call only. Call waiting is activated (and deactivated) by sending the key sequence “*70” to the central office, and is deactivated by the sending same code. Call tracing functions can be performed by transmitting the dial sequence “*57” to the central office, which thereafter provides announcements to the subscriber indicating that the call was traced and providing further instructions. The central office may be requested to perform repeat dialing by sending the key sequence “*66”. Repeat dialing by the central office may be deactivated on the request of the subscriber transmitting the dialtone sequence “*68” to deactivate central office repeat dialing.

Under the commonly available “three way calling” service offered by telephone system, when the user wishes to add a third party to an ongoing call, he or she may manually flash the line (i.e., places the line on-hook momentarily), waits for three beeps and a dial tone from the central office, then dials the number, and when the added party answers, again flashes the line to bring all three parties together for the desired conferenced call. If the third party line does not answer or is busy, the subscriber is notified of that condition and the line is flashed twice to reconnect the first call. These functions may be combined with pre-recorded telephone numbers to automatically create conference calls by selecting the recorded control sequence for playback, either manually or when the condition part of a rule is satisfied. As noted above, using special dialtone DTMF sequences, SS7 signaling, or the like, pre-recorded message files may be transmitted directly into a destination voice mail system. Thus, the rule-based mechanism may be employed to automatically perform voice mail management functions. Thus, a cell phone user could record a message and define a rule which would cause the recorded message to be automatically transferred into the voice mail system of a particular person. For example, “If a product designated by EPC Code 123456789012 and EPC Reader 987654 are close together, send the message labeled “Your shipment arrived” to the voice mail of (508) 555-1212.”

The cellular phones typically include built-in GPS (Global Positioning System) receivers for continuously or periodically updating location data for that device. For details on the Global Positioning System and GPS receivers, see Understanding GPS:Principles and Applications by Elliott D. Kaplan (Editor), Artech House; ISBN 0890067937 (1996). In addition, Mobile Positioning Systems (MPS) incorporated into cellular phone systems provide a mechanism for periodically updating location information for those devices. MPS technology is similar to the. satellite-based Global Positioning Systems (GPS) but offers the additional capability of determining location inside buildings, parking garages and other shielded areas such as inside a pocket or briefcase that are inaccessible to GPS systems. MPS Mobile Positioning Systems for mobile phones are offered by Ericsson, Nokia. cellPoint, SnapTrack, Cell-loc, Cambridge Positioning System, and others.

The location data provided by GPS and MPS systems specifies the geographic “point” position of each phone. Request messages sent to the server 311 may include precise point data when available, or may approximate a position by specifying defined regions which contain the objects. Preferably, location data and mapping data is stored in a standard format, such as that used by the locator feature in Oracle8i(or later) and its spatial geometry format, a component of the Oracle 8i™ database available from Oracle Corporation, Redwood Shores, Calif. Oracle Spatial and its extensions as used with the Oracle8i Enterprise Edition provides an integrated set of functions and procedures that enables spatial data to be stored, accessed, and analyzed quickly and efficiently in an Oracle8i database. Oracle Spatial provides a SQL schema and functions that facilitate the storage, retrieval, update, and query of collections of spatial features in an Oracle8i database, and includes a set of operators and functions for performing area-of-interest and spatial join queries. See the Oracle Spatial User's Guide and Reference, Release 8.1.6, (Oracle Part No. A77132-01), 1997, 1999. The Oracle8i Spatial products use the geocoding process for converting an address or street intersection information into a geographical location specified by a latitude and longitude. Oracle8i Spatial may accordingly be used to support web-based searches by proximity from a given location and is designed to facilitate tasks such as supplementing business information with a location attribute (latitude and longitude) and to perform distance queries, and to present a graphical representation of locations for easier visualization by users.

Using Relative Location to Control Alerts

Ways of using such “relative” location information (that is, the phone knows where it is relative to other devices the user may own or control) to modulate ring volume and mode are many. One important technique uses information concerning the location of the user; for example, if the user was determined to be many feet away, the phone would ring louder than if the user were nearby. For example, Bluetooth transceivers in the portable phone and in a wristwatch worn by the portable phone users could detect one another to establish that the user is “near” the phone.

Because the distance separating two entities can be repeatedly measured at a rapid rate, the comparing successive distance measurements allows the rate at which two objects are approaching one another, or separating from one another, to be determined. Thus, the ring tone may be lowered as the user walked towards the phone. The ringing may also be programmed to cease, or decrease in volume, if the phone ascertained that the person was indeed walking toward the phone. In addition, the ringing phone could make a sound (e.g. distinctive ringing) that indicated that the phone's awareness that the user was approaching the phone, and provide a distinctive ring sound as if to say, “take your time, no rush”. Similarly, more aggressive ringing could commence if the movement tracking indicated that the person wasn't heading toward the phone.

In other situations, location data can be used to alter ring volume and/or ring mode based on the relative location of other items relative to the location of the location of the portable phone. For instance, if a position indicating device (e.g. a “beacon”), such as a Bluetooth transceiver, an infrared device, or an RFID tag, were embedded in a baby seat or placed in a child's room, then when the portable phone is positioned near the device which acts as a beacon identifying a “quiet zone,” the alert volume or mode may be changed to prevent loud ringing. Such beacons could also be placed in theaters, churches, libraries, and other places where annoying alert signals (and cellphone use in general) are to be discouraged.

The detection of nearby objects may also be used to ascertain if the phone was at a location where ringing should be more aggressive; for example, when the phone is inside of a briefcase or a woman's pocketbook. In that event, the phone might ring louder or a distinctive ringing mode may be used.

In other circumstances where vibrate mode had been selected as the desired mode to answer the phone (in the office for instance), the phone might switch to an audible ringing mode if the relative location detection method indicated that user had left the phone and was not then close to it. Such a mode would be particularly useful those who typically do not carry their portable telephone around the office, but leave it at their desk or in a coat pocket. The handset could then most efficiently “find” its owner by selectively using different signaling strategies depending on the owner's location.

To Vary Ring Length

In certain situations, location detection may be used to not only control ring tone volume and/or mode, but also the length of time that the phone will ring before the call is sent to voice mail. For instance, when it is determined that the user being far from the phone, the ringing volume may be increased and, in addition, the ringing time could be increased as well to allow the user more time to answer the phone before the call is sent to voice mail. This Long Answer Mode could offer a choice between a short or a long ring time interval, or the ringing duration could be continuously adjusted to a time duration which varies in relation to the measured distance between the phone and the user.

Adaptive Learning

The ring-time-to-distance/location relationship could be set explicitly by the user. For instance, the user could specify that if he was within 50 feet of the phone, or in specific rooms, that the phone should ring for a certain number of rings. Alternatively, the system could “learn” the optimal ring-time. For instance, if the location sensing mechanism could deduce that the user was away from the phone and in the bathroom, it could “know” from experience that the user would not answer the phone. In that case, it might not even try and just the call to voicemail more quickly.

The manner in which alert signals are generated in response to the location determination may be adaptive; that is, the desired alert volume, mode or ringing duration to be used in a given situation may be learned from experience. Thus, whenever the user in a detectable location, such as conference room, recorded data may indicate that the user typically takes longer to answer the phone. Similarly, it may be learned that if the handset is in the dark during daylight hours, then the time within which calls are answered is longer. Without special programming, the system may learn the relationship between sensed locations and environmental conditions, or combinations of these, and recurring delays in answering the phone, and adaptively alter the ringing characteristics to adapt to these learned conditions.

The system could learn via experience that if the phone rings for a certain number of times, it indicates that the user will not answer the phone no matter how long it rings. Thus, if the system created a distribution curve of rings vs. the probability that the user will eventually answer the phone the system would stop ringing once that probability passed a certain threshold.

Communicating with the Caller

The system may also be used to communicate information concerning the status of a called party, or the ringing strategy being employed to alert the called party, to the caller at the time of the call. For instance, if the called party is determined to be far from the phone, and the system extends delay time before the caller is to be sent to voice mail, the caller may be informed by a recorded voice message such as: “We are trying to locate that party, please wait”. When such a message is issued, the caller may be given a choice of waiting or going into voicemail.

In addition, the ringback tone might communicate this information either by using a different tone or giving a voice message. This message might explicitly explain that the party being called was some distance from the phone or could tell the caller how long the phone would keep ringing before going into voicemail. This message could be recorded in the voice of the party being called.

In summary, the system may automatically respond to sensed locations, nearby objects, the time of day, sensed environmental conditions, or combinations of these specified by rules-based conditions, to automatically control the volume of the alert, vary its mode, adjust the length of such alert, and communicate information about the alert process to the caller.

Remote Ringing

When using a landline phone in a house, a user is afforded the opportunity to purchase additional handsets which can ring at various locations around a house. This allows for a somewhat even ring volume among many rooms. A portable telephone does not offer this option.

A method to offer such a service on a portable telephone would be to use Bluetooth to interface the ringing portable telephone to remote ringers. (This is done today in one fashion by a holster that allows the portable telephone to ring through on whatever landline system the user has. If one doesn't have a landline or this type of cross-platform interface, another solution like the one proposed is needed.) See, for example, U.S. Application Publication No. 2005/0101261 entitled “Bluetooth interface between cellular and wired telephone networks” by Carmi Weinzweig et al. which describes a mechanism for using a Bluetooth connection between a cellular phone and a wired phone system.

To make alert a user when traditional alert signals from a portable phone that is far away or in an enclosure can't easily be perceived, the alert signal can be sent to a remote ringer that the user carries with them or which is placed on or close to the outside of a pocketbook, briefcase, or other storage compartment. Such a ringer could be programmed to ring at a volume different from that of the base portable telephone that it was representing.

Remote ringers and the portable phone may employ distance sensors so that only that ringer (on the phone or one of the remote ringers) which is closed to the called party will be activated, thereby avoiding a cacophony of sound when a call arrives. This single-ringing device could offer a quieter solution overall than having one handset ring very loudly in order to alert a user who might be anywhere in a house.

Ring Volume and Mode Controlled by Calling Party

The nature of the alert signal may be controlled completely or in part by the calling party according to the urgency of the call. For example, the caller could override the usual number of rings that a phone offers before going into voice mail. Such overrides can be applied only when the called party gives permits such overrides to be used, and such a permission may be extended to designated callers only.

As discussed above, the phone being called (using position sensing technology) might have data determining that the user was approaching the phone as it rang. This information, as well as information that the user was within a certain distance to the phone, are data that could be passed to the calling party as the phone was ringing. The calling party could then ascertain the likelihood of the receiving party answering the phone and wait for such an answer or extend the ringing time as mentioned above.

Data from Photo Sensors

As indicated at 122 in FIG. 1, a light sensor may be used to determine whether or not the phone is in the dark. Output from the light sensor may be used to increase the ring volume and mode when the phone is in the dark during daylight hours, and may be used in combination with motion sensing and the time of day clock to suppress ringing when the phone is in the dark and at rest during the early morning hours when it is likely the called party is sleeping and does not wish to be disturbed. The light sensor data may be used in combination with location data to confirm that the portable phone is likely in a particular location, such as in a coat pocket in a closet which suggests the need for increased ringing volume.

Data from Microphone

The microphone of a portable telephone, as seen at 121 in FIG. 1, might be usefully employed as well to determine a suitable ringing volume. Such a microphone could discern the level of ambient noise and make the appropriate adjustments to the ringing volume in much the same way that a car radio turns itself up or down as the car speeds up and slows down (thus making more or less noise). If the level were high enough, the handset might switch to vibrate mode. Such volume and mode changes might be made by combining input from microphone data as well as other forms of data described in this invention.

The same ambient noise detection mechanism system may be used to help control the volume of the actual voice being heard after the call in answered. In this case, the microphone will pick up and hear both the ambient noise and the recipient's voice. There would normally be a distinct difference in sound volumes between the two, however, resulting in somewhat of a bi-modal distribution pattern of sound coming into the microphone. With such a bi-modal distribution, the handset would be able to separate the signal from noise and understand the level of ambient noise. With that understanding, the system could increase the call volume of the incoming caller's voice.

The combination of ambient noise detection and voice recognition may be used to preferentially amplify the user's voice relative to the background noise. In addition to improving the signal-to-noise ratio for the transmitted voice signal, this mechanism would reduce the need for the speaker to talk more loudly and hence reduce the annoyance to those who are nearby.

Data from Capacitive Sensors

One common annoyance of answering a portable telephone is that one must open the case or take other action to get the phone to stop ringing when one picks it up. If the handset had a simple pressure sensor or capacitive sensor, illustrated at 123 in FIG. 1, that sensed capacitive loads or applied pressure caused by touching the phone's surface, the unit could determine when it had been picked up. At that point the phone could stop ringing (although the connection might not necessarily be made). The user could check the displayed Caller ID and decide if he or she wanted to answer the phone or not. The unit could also switch to vibrate mode when picked up, if it was necessary to signal to the user that the call was still waiting to be answered.

If a user desired to place a portable phone in vibrate mode, that mode could be programmed to continue only as long as the phone was held in the user's hand. In this way, the user could prevent ringing for expected incoming calls by holding the phone until the call came in. Thereafter, when the phone was put down, it would switch back to an audible ringing mode from the vibrate mode.

Time-Based Data

On many occasions, it is not a good time to receive calls, or at a minimum, alert characteristics should be modified. These times can include meetings, doctors' appointments, and school classes. These event times (start and end times) can exist in a user's calendar database which can be augmented when created with an indication of whether on not calls are to be sent to voice mail during the scheduled time of the meeting, during particular hours of the day (e.g. after midnight and before 6:00 AM). At the beginning of each event (or some pre-determined time before or after the start of such an event), the change in alert characteristics would occur. In some cases, multiple changes in alert characteristics could occur around or during such an event.

While the user could certainly set some of these alert characteristics by himself, this system offers the advantage of doing it automatically, and further more, offers the ability to go to another set of characteristics after the given event—a task many users forget to do as they leave the movie theatre or other locale where they have turned their phone off.

A more generalized basis for modifying the alert characteristics would be to make alert characteristics a function of time of day, day of week, or date. That is, if one were a church volunteer, that person would set his ring tone mode to manner mode only on Sunday. Furthermore, the modification could be programmed to last a certain period of time—in this example, the length of the service and only during that time of the day.

Another example would be users who would use the system to set alert characteristics for times when they would be sleeping. The user could schedule set regular periods (such as nighttime) when the alerts would behave a certain way (be silent, referring callers immediately into voicemail).

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A method for controlling a portable telephone comprising, in combination, the steps of:
producing an indication of the current position of said portable telephone, and
producing an alert that can be perceived by a human in response to an incoming telephone call directed to said portable telephone, said alert having one or more properties that are dependent upon said indication of the current position of said portable telephone.

2. A method for controlling a portable telephone as set forth in claim 1 wherein said step of producing said indication of the current position of said portable telephone specifies said position relative to the current location of another object, person or region.

3. A method for controlling a portable telephone as set forth in claim 2 wherein said current location of another object, person or region is the current location of a beacon that emits a signal that can be detected by a sensor in said portable telephone when said portable telephone is in the vicinity of said beacon.

4. A method for controlling a portable telephone as set forth in claim 2 wherein said current location of another object, person or region is the current location of the human user of said portable telephone.

5. A method for controlling a portable telephone as set forth in claim 2 wherein said current location of another object or person is a predetermined fixed geographical location.

6. A method for controlling a portable telephone as set forth in claim 1 wherein said alert is an audible, visible or tactile notification signal having a magnitude which is dependent upon said indication of the current position of said portable telephone.

7. A method for controlling a portable telephone as set forth in claim 6 wherein said alert is an audible notification signal having a magnitude which is dependent upon said indication of the current position of said portable telephone.

8. A method for controlling a portable telephone as set forth in claim 1 wherein said alert is an audible notification signal whose timing is dependent on said indication of the current position of said portable telephone.

9. Apparatus for controlling the operation of a portable telephone comprising, in combination,
one or more inputs for acquiring one or more data values indicating the current status of said portable telephone,
a signal generator for producing a notification alert in response to and indicative of an incoming telephone call directed to said portable telephone, and
means responsive to said one or more data values for altering one or more attributes of said notification signal.

10. Apparatus for controlling the operation of a portable telephone as set forth in claim 9 wherein at least one of said data values indicates the current location of said portable telephone.

11. Apparatus for controlling the operation of a portable telephone as set forth in claim 10 wherein said one of said data values that indicates the current location of said portable telephone is obtained by detecting a signal transmitted from a remote beacon source having a known location.

12. Apparatus for controlling the operation of a portable telephone as set forth in claim 10 wherein said one of said data values that indicates the current location of said portable telephone is obtained using the Global Positioning System.

13. Apparatus for controlling the operation of a portable telephone as set forth in claim 9 wherein at least one of said data values indicates the location of said portable telephone relative to the location of another object.

14. Apparatus for controlling the operation of a portable telephone as set forth in claim 9 wherein at least one of said data values indicates the level of ambient sound at said portable telephone.

15. Apparatus for controlling the operation of a portable telephone as set forth in claim 14 wherein at least one of said data values indicates the level of ambient light at said portable telephone.

16. Apparatus for controlling the operation of a portable telephone as set forth in claim 15 wherein said means responsive to said one or more data values for altering one or more attributes of said notification signal alters the intensity of said notification signal.

17. Apparatus for controlling the operation of a portable telephone in response to the changing distance between of said portable telephone and a remote object, said apparatus comprising, in combination:
an electronic device that can be identified at short range attached to or forming a part of said remote object,
detection means for generating position data indicating the distance between said portable telephone and said electronic device, and
means for controlling one or more functions performed by said portable telephone in accordance with said position data.

18. Apparatus for controlling the operation of a portable telephone as set forth in claim 17 wherein said one or more functions includes producing an alert notification signal indicating that an incoming telephone call has been directed to said portable telephone wherein the magnitude or timing of said notification signal is controlled in accordance with said position data.

19. Apparatus for controlling the operation of a portable telephone as set forth in claim 18 wherein said one or more functions includes generating said notification signal for a period of time prior to directing said incoming call to voice mail wherein said period of time is varied in accordance with said position data.

20. Apparatus for controlling the operation of a portable telephone as set forth in claim 18 wherein said remote object is carried by the human user of said portable telephone.
